(19) United States
(12) Patent Application Publication
(10) Pub. No.: US 2009/0042762 A1
(43) Pub. Date: Feb. 12, 2009

(54) CLEANER COMPOSITION FOR REMOVAL OF LEAD-FREE SOLDERING FLUX, RINSING AGENT FOR REMOVAL OF LEAD-FREE SOLDERING FLUX, AND METHOD FOR REMOVAL OF LEAD-FREE SOLDERING FLUX

(75) Inventor: Kazutaka Zenfuku, Osaka (JP)

Correspondence Address: KRATZ, QUINTOS & HANSON, LLP, 1420 K Street, N.W., Suite 400, WASHINGTON, DC, 20005, US

(73) Assignee: ARAKAWA CHEMICAL INDUSTRIES, LTD., OSAKA-SHI (JP)

(21) Appl. No.: 12/280,720

(22) PCT Filed: Mar. 16, 2007
(86) PCT No.: PCT/JP2007/055362

§ 371 Date: Aug. 26, 2008

(30) Foreign Application Priority Data
Mar. 17, 2006 (JP) 2006-075199

(51) Int. Cl. C11D 7/36

(52) U.S. Cl. 510/175

(57) ABSTRACT

The present invention provides a cleaner composition that can satisfactorily remove lead-free soldering flux adhered to the object to be cleaned, has little impact on the environment, and has odor, inflammability, etc., which are of an acceptable level for practical use; a rinsing agent for rinsing the cleaned object after cleaning with the cleaner composition to remove lead-free soldering flux more effectively; and a removal method using the composition (and the rinsing agent). The cleaner composition for the removal of lead-free soldering flux contains:
(A) a polyoxyalkylene phosphate-based surfactant,
(B) a metal chelating agent, and
(C) a halogen-free organic solvent;
and the rinsing agent for removal of lead-free soldering flux contains a carbonate represented by

MₐH_{b}(CO₃)_{C} General Formula (7)

where a is an integer of 1 or 2, b is an integer of 0 to 2, c is an integer of 1 or 2, and M is a volatile organic base.

### TECHNICAL FIELD

The present invention relates to a cleaner composition for the removal of lead-free soldering flux, a rinsing agent for the removal of lead-free soldering flux, and a method for the removal of the same.

### BACKGROUND ART

In the fabrication of electronic components, semiconductor components and like precision components, soldering is usually performed. Eutectic solder containing lead has conventionally been used in soldering. Usually, solder contains flux. The flux cleans the object to be soldered and the surface of the solder so as to enhance the wettability of the solder to the object. Accordingly, flux-containing solder can enhance the adhesion between the solder and the object. The flux usually contains, as constituent components, rosin, rosin derivatives and like base resins; organic acids, halides and like activators; and alcohols and like solvents.

After soldering, precision components are washed so as to remove the extra solder flux remaining on the surfaces thereof. In the washing process, a chlorine-containing cleaning agent, which contains trichloroethylene, perchloroethylene, methylene chloride or a like chlorine-containing solvent as a main component, has heretofore been used. Such chlorine-containing cleaning agents are advantageous in that they are nonflammable and have excellent drying properties. However, the use of chlorine-containing cleaning agents is currently restricted because they cause ozone layer depletion, soil pollution and like environmental problems; they are toxic to humans; etc. Furthermore, in cleaning electronic components, etc., no significant cleaning effects against chlorine ions, sulfate ions and like ionic residues are observed.

Patent Document 1 discloses a halogen-free cleaning composition that contains a specific glycol ether, nonionic surfactant and polyoxyalkylene phosphate-based surfactant as essential components. Patent Document 2 discloses a halogen-free cleaning composition that comprises a polyoxyalkylene amine-based surfactant in addition to the components of the cleaning agent composition disclosed in Patent Document 1.

These cleaning compositions exhibit excellent cleaning abilities (especially on ionic residues), and they have little toxicity, offensive smell, flammability, and adverse affects on the object to be cleaned (for example, corrosion of the cleaned object). Therefore, they can suitably be used as compositions for removing solder flux adhered to precision components, such as optical components, electronic components, and ceramic components.

In recent years, people have become aware of the hazards of lead, and the use of lead-containing solder has been restricted in several countries. Accordingly, lead-free solder that contains copper, silver, etc., instead of lead, has been increasingly used. Examples of lead-free solders include those that use alloys of tin-silver, tin-copper, tin-silver-copper, etc.

When a lead-free solder is used, except for some cases where specific alloy-based lead-free solders are used, the soldering temperature has to be set higher by at least 30° C. than would be the case if a known tin-lead eutectic solder was used, and its solder wettability is inferior to that of the known eutectic solder. In order to solve such problems, the amount of activator used in a lead-free solder is increased, or a stronger activator is used compared to that normally used in lead-free soldering.

However, when such a lead-free solder is used, various reaction products tend to be produced during the soldering process. Examples of such reaction products include salts of the activator and tin, and, specifically when a rosin-based flux is used, salts of rosin and tin, etc. Because these reaction products are metal salts of divalent or tetravalent tin, which are barely dissolved in several solvents, cleaning compositions, water, etc., it is extremely difficult to remove them from the object being cleaned. Specifically, when cleaning is conducted using a known halogen-free cleaning composition and/or a polar or non-polar organic solvent, due to its insufficient ability to remove the tin salt, flux residues attributable to the tin salt remain on the surface of the cleaned object, or pollutants attributable to the tin salt will re-attach to the surface of the cleaned object.

Patent Document 1: Japanese Examined Patent Publication No. 1993-40000

Patent Document 2: Japanese Patent No. 2813862

### DISCLOSURE OF THE INVENTION

### Problem to be Solved by the Invention

An object of the present invention is to provide a cleaner composition that can satisfactorily remove lead-free soldering flux adhered to the object being cleaned, has little impact on the environment, and has odor, inflammability, etc., satisfactorily suppressed to a level that is practical. Another object of the present invention is to provide a rinsing agent that can remove lead-free soldering flux more effectively after cleaning the object with the cleaner composition; and a removal method using the cleaning composition (and the rinsing agent).

### Means for Solving the Problem

The present inventors conducted extensive research to achieve the above object, and found that by using a specific cleaner composition, a specific rinsing agent, and a specific removal method, the object can be achieved. The present invention has been accomplished based on these findings.

Specifically, the present invention provides a cleaner composition for the removal of lead-free soldering flux, a rinsing agent for the removal of lead-free soldering flux, and a method for the removal of lead-free soldering flux as described below.

1. A cleaner composition for removing lead-free soldering flux comprising:

(A) a polyoxyalkylene phosphate-based surfactant;

(B) a metal chelating agent; and

(C) a halogen-free organic solvent.

2. A cleaner composition for removing lead-free soldering flux according to Item 1, wherein the (A) polyoxyalkylene phosphate-based surfactant is a polyoxyethylene phosphate-based surfactant represented by General Formula (1) or a salt thereof:

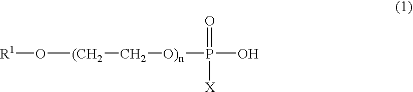

where R¹ is a C₅₋₂₀ straight-chain or branched alkyl or phenyl group, or a phenyl group substituted with a C₇₋₁₂ straight-chain or branched alkyl group, n is an integer of 0 to 20, and X is a hydroxyl group or a group represented by General Formula (2):

R²—O(CH₂CH₂—O)ₘ— (2)

where R² is a C₅₋₂₀ straight-chain or branched alkyl or phenyl group, or a phenyl group substituted with a C₇₋₁₂ straight-chain or branched alkyl group, and m is an integer of 0 to 20.

3. A cleaner composition for removing lead-free soldering flux according to Item 1, wherein the (B) metal chelating agent is at least one member selected from the group consisting of hydroxycarboxylic acid-based chelating agents, carboxylic acid-based chelating agents and phosphoric acid-based chelating agents.

4. A cleaner composition for removing lead-free soldering flux according to Item 1, which further comprises at least one member selected from the group consisting of (D) nonionic surfactants and (E) polyoxyalkylene amine-based surfactants.

5. A cleaner composition for removing lead-free soldering flux according to Item 1, wherein the (C) halogen-free organic solvent is at least one member selected from the group consisting of a glycol ether compound represented by General Formula (3):

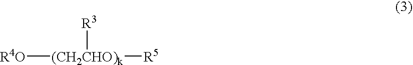

wherein R³ is a hydrogen atom or a methyl group, R⁴ is a hydrogen atom or a C₁₋₅ straight-chain or branched alkyl group, R⁵ is a C₁₋₅ straight-chain or branched alkyl group, and k is an integer of 2 to 4; and

a nitrogen-containing compound represented by General Formula (4):

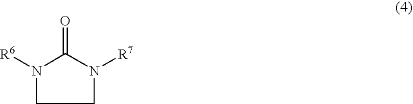

where R⁶ is a hydrogen atom or a C₁₋₅ straight-chain or branched alkyl group, R⁷ is a hydrogen atom or a C₁₋₅ straight-chain or branched alkyl group.

6. A cleaner composition for removing lead-free soldering flux according to Item 4, wherein the (D) nonionic surfactant is a nonionic surfactant represented by General Formula (5):

R⁸O—(CH₂CH₂O)ᵣ—(CH₂CR⁹HO)ₛ—H (5)

where R⁸ is a C₆₋₂₀ straight-chain or branched alkyl or phenyl group, or a phenyl group substituted with a C₇₋₁₂ straight-chain or branched alkyl group, R⁹ is a hydrogen atom or a methyl group, r is an integer of 0 to 20, s is an integer of 0 to 20, and r+s is an integer of 2 to 20.

7. A cleaner composition for removing lead-free soldering flux according to Item 4, wherein the (E) polyoxyalkylene amine-based surfactant is a polyoxyethylene amine-based surfactant represented by General Formula (6):

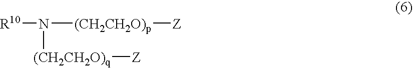

where R¹⁰ is a hydrogen atom or a C₁₋₂₂ straight-chain or branched alkyl or alkenyl group, Z is a hydrogen atom or a C₁₋₄ straight-chain or branched alkyl or acyl group, p is an integer of 1 to 15, and q is an integer of 0 to 15.

8. A cleaner composition for removing lead-free soldering flux according to Item 1, wherein the contents of the components of the (A) polyoxyalkylene phosphate-based surfactant, (B) metal chelating agent, and (C) halogen-free organic solvent are (A) 0.1 to 60 weight %, (B) 0.01 to 10 weight %, and (C) 39 to 99 weight % respectively when the total weight of the three components is defined as 100 weight %.

9. A cleaner composition for removing lead-free soldering flux according to Item 4, which contains 0.1 to 150 parts by weight of the (D) nonionic surfactant when the total amount of the (A) polyoxyalkylene phosphate-based surfactant, (B) metal chelating agent, and (C) halogen-free organic solvent is defined as 100 parts by weight.

10. A cleaner composition for removing lead-free soldering flux according to Item 4, which contains 0.1 to 150 parts by weight of the (E) polyoxyalkylene amine-based surfactant when the total amount of the (A) polyoxyalkylene phosphate-based surfactant, (B) metal chelating agent, and (C) halogen-free organic solvent is defined as 100 parts by weight.

11. A cleaner composition for removing lead-free soldering flux according to Item 1, wherein an aqueous solution that contains 1 weight % of (A) polyoxyalkylene phosphate-based surfactant, (B) metal chelating agent, and (C) halogen-free organic solvent in total has a pH of 2 to 10.

12. A rinsing agent for removing lead-free soldering flux containing a carbonate represented by General Formula (7):

MₐH_{b}(CO₃)_{C} (7)

where a is an integer of 1 or 2, b is an integer of 0 to 2, c is an integer of 1 or 2, and M is a volatile organic base.

13. A method for removing lead-free soldering flux comprising a step of removing flux by contacting the cleaning composition of Item 1 with a lead-free soldering flux.

14. A method for removing lead-free soldering flux comprising a step of, after contacting the cleaning composition of Item 1 with a lead-free soldering flux, rinsing using a rinsing agent to remove the lead-free soldering flux, the rinsing agent containing a carbonate represented by General Formula (7):

MₐH_{b}(CO₃)_{C} (7)

where a is an integer of 1 or 2, b is an integer of 0 to 2, c is an integer of 1 or 2, and M is a volatile organic base.

The cleaner composition of the present invention cleans electronic components, semiconductor components and like precision components, which have been soldered using a lead-free solder.

The lead-free solder contains metal components and flux components. Examples of the metal components include alloys of tin-silver, tin-copper, tin-silver-copper, etc. These alloys may be used singly or in combination. There is no limitation to the flux components, and usable examples include fluxes containing a base resin, activator and solvent. Examples of the base resins include rosin, rosin derivatives, etc. Examples of the activators include organic acids, halides, etc. One example of the solvents is alcohol.

One example of the electronic components is a printed-circuit board. One example of the semiconductor components is a semiconductor packaging.

In the present specification, lead-free soldering flux means a flux component in a lead-free solder. In the present invention, the lead-free soldering fluxes to be removed include not only flux components remaining after soldering, but also reaction products between a metal and flux component contained in a lead-free solder, and pollutants attributable to the metal and/or the reaction products, etc.

Examples of the reaction products include insoluble tin salts, etc. The cleaner composition and rinsing agent of the present invention exhibit excellent abilities especially in removing insoluble tin salts and preventing the re-adhesion thereof.

### Cleaner Composition

The cleaner composition for the removal of lead-free soldering flux of the present invention contains:

(A) a polyoxyalkylene phosphate-based surfactant (hereunder this component is referred to as Component (A));

(B) a metal chelating agent (hereunder this component is referred to as Component (B)); and

(C) a halogen-free organic solvent (hereunder this component is referred to as Component (C)).

There is no limitation to the Component (A) as long as it is a polyoxyalkylene phosphate-based surfactant, and a known polyoxyalkylene phosphate-based surfactant may be used. In particular, preferable examples of the Component (A) are polyoxyethylene phosphate-based surfactants represented by General Formula (1), and salts thereof:

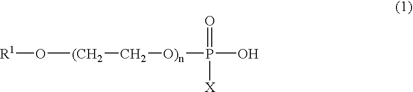

where R¹ is a C₅₋₂₀ straight-chain or branched alkyl or phenyl group, or a phenyl group substituted with a C₇₋₁₂ straight-chain or branched alkyl group, n is an integer of 0 to 20, and X is a hydroxyl group or a group represented by General Formula (2):

R²—O(CH₂CH₂—O)ₘ— (2)

where R² is a C₅₋₂₀ straight-chain or branched alkyl or phenyl group, or a phenyl group substituted with a C₇₋₁₂ straight-chain or branched alkyl group, and m is an integer of 0 to 20.

Use of the polyoxyethylene phosphate-based surfactant or a salt thereof significantly enhances the cleaning ability of the cleaner composition of the present invention, particularly when the cleaner composition is used after being diluted with water.

When R¹ is a C₅₋₂₀ straight-chain or branched alkyl group, examples of the alkyl groups include pentyl, hexyl, heptyl, octyl, nonyl, decyl, undecyl, dodecyl, tridecyl, ethylhexyl, etc. When R¹ is a phenyl group substituted with a C₇₋₁₂ straight-chain or branched alkyl group, examples of the phenyl groups include octylphenyl, nonylphenyl, decylphenyl, dodecylphenyl, etc.

Preferable examples of R¹ include decyl, dodecyl, tridecyl and like C₁₀₋₁₄ straight-chain or branched alkyl groups; or phenyl groups substituted with octylphenyl, nonylphenyl, decylphenyl and like C₈₋₁₂ straight-chain or branched alkyl groups.

In General Formula (1), n is preferably an integer of 2 to 18, and particularly preferably 8 to 18.

When R² is a C₅₋₂₀ straight-chain or branched alkyl group, examples of the alkyl groups are the same as those mentioned in the explanation of R¹. When R² is a phenyl group substituted with a C₇₋₁₂ straight-chain or branched alkyl group, examples of the phenyl groups are the same as those mentioned in the explanation of R¹¹. Preferable examples of R² are phenyl groups substituted with a C₁₀₋₁₄ straight-chain or branched alkyl group.

In General Formula (2), m is preferably an integer of 2 to 18, and particularly preferably an integer of 8 to 18.

Examples of the salts include sodium salts, potassium salts and like metal salts, ammonium salts, alkanolamine salts, etc.

There is no limitation to the Component (B) as long as it is a metal chelating agent, other than Component (A), that can coordinate with metal ions, and a known metal chelating agent can be used. Examples of usable chelating agents include carboxylic acid-based, amino acid-based, phosphonic acid-based, phosphate-based, aminocarboxylic acid-based, hydroxycarboxylic acid-based chelating agents, etc.

Examples of the carboxylic acid-based chelating agents usable in the present invention include oxalic acid, malonic acid, succinic acid, glutaric acid, adipic acid, itaconic acid, acetylsalicylic acid, phthalic acid, trimellitic acid, cyclopentane tetracarboxylic acid, etc.

Examples of the amino acid-based chelating agents usable in the present invention include glycine, alanine, lysine, arginine, asparagine, tyrosine, etc.

Examples of the phosphonic acid-based chelating agents usable in the present invention include ethyl phosphonic acid, octyl phosphonic acid and like alkyl phosphonic acids, hydroxyethane diphosphonic acid, nitrilotrismethylene phosphonic acid, N,N,N′,N′-tetrakis(phosphonomethyl)ethylenediamine, etc.

Examples of the phosphate-based chelating agents usable in the present invention include orthophosphoric acid, pyrophosphoric acid, triphosphoric acid, polyphosphoric acid, etc.

Examples of the aminocarboxylic acid-based chelating agents usable in the present invention include ethylenediaminetetraacetic acid (EDTA), cyclohexanediamine tetraacetic acid (CDTA), nitrilotriacetic acid (NTA), diethylenetriaminepentaacetic acid (DTPA), iminodiacetate (IDA), N-(2-hydroxyethyl)iminodiacetic acid (HIMDA), hydroxyethylethylenediamine triacetic acid (HEDTA), etc.

Examples of the hydroxycarboxylic acid-based chelating agents usable in the present invention include malic acid, citric acid, isocitric acid, glycolic acid, gluconic acid, salicylic acid, tartaric acid, lactic acid, etc.

The above mentioned chelating agents may be sodium salts, potassium salts, ammonium salts and like salts, or hydrolysable ester derivatives.

In the present invention, it is preferable that at least one metal chelating agent selected from the group consisting of hydroxycarboxylic acid-based chelating agents, carboxylic acid-based chelating agents and phosphate-based chelating agents be used. Use of a hydroxycarboxylic acid-based chelating agent is particularly preferable because it is highly soluble in insoluble tin salts formed by the reaction during the soldering process in which a lead-free solder is used or because it can disperse insoluble tin salts excellently.

There is no limitation to the Component (C) usable in the present invention as long as it is a halogen-free organic solvent other than that of Components (A) and (B), and known halogen-free organic solvents can be used. Specific examples thereof include hexane, heptane, octane and like hydrocarbon-based solvents; methanol, ethanol, propanol and like alcohol-based solvents; acetone, methyl ethyl ketone and like ketone-based solvents; diethyl ether, tetrahydrofuran, glycol ether compounds and like ether-based solvents; ethyl acetate, methyl acetate and like ester-based solvents; nitrogen-containing compound based solvents and other known organic solvents. In terms of cleaning ability or the like, at least one solvent selected from the group consisting of glycol ether compounds and nitrogen-containing compounds is particularly preferable as the Component (C).

Because it has excellent cleaning ability and is safe and environmentally friendly, among the glycol ether compounds, a glycol ether compound represented by General Formula (3):

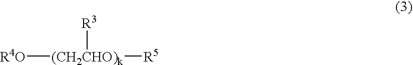

where R³ is a hydrogen atom or a methyl group, R⁴ is a hydrogen atom or a C₁₋₆ straight-chain or branched alkyl group, R⁵ is a C₁₋₆ straight-chain or branched alkyl group, and k is an integer of 2 to 4 is particularly preferable.

When R⁴ is a C₁₋₆ straight-chain or branched alkyl group, examples of the alkyl group include methyl, ethyl, propyl, iso-propyl, butyl, sec-butyl, tert-butyl, pentyl, hexyl, etc. Among these, a hydrogen atom, ethyl, butyl, sec-butyl and tert-butyl are particularly preferable.

Examples of R⁵ include the alkyl groups mentioned in the explanation of R⁴. Ethyl and butyl are particularly preferable as R⁵.

Examples of glycol ether compounds represented by General Formula (3) include diethylene glycol monomethyl ether, diethylene glycol dimethyl ether, diethylene glycol monoethyl ether, diethylene glycol diethylether, diethylene glycol methyl ethyl ether, diethylene glycol monopropyl ether, diethylene glycol dipropyl ether, diethylene glycol methyl propyl ether, diethylene glycol ethyl propyl ether, diethylene glycol monobutyl ether, diethylene glycol dibutyl ether, diethylene glycol methyl butyl ether, diethylene glycol ethylbutyl ether, diethylene glycol propylbutyl ether, diethylene glycol monopentyl ether, diethylene glycol dipentyl ether, diethylene glycolmethylpentyl ether, diethylene glycol ethylpentyl ether, diethylene glycol propylpentyl ether, diethylene glycol butyl pentyl ether, diethylene glycol monohexyl ether, and tri- or tetra-ethylene glycol ether compounds of these ethers. Among these, diethylene glycol monobutyl ether, diethylene glycol dibutyl ether, and diethylene glycol monohexyl ether are particularly preferable.

Among the nitrogen-containing compounds, a compound represented by General Formula (4):

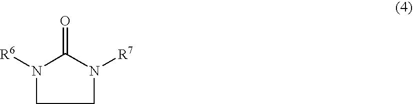

where R⁶ is a hydrogen atom or a C₁₋₅ straight-chain or branched alkyl group, and R⁷ is a hydrogen atom or a C₁₋₅ straight-chain or branched alkyl group; is preferable.

When R⁶ is a C₁₋₅ straight-chain or branched alkyl group, usable examples of the alkyl group are the same as those mentioned in the explanation of R⁴. Among those, methyl, ethyl, propyl, iso-propyl, butyl, sec-butyl, tert-butyl and pentyl groups are particularly preferable.

When R⁷ is a C₁₋₅ straight-chain or branched alkyl group, examples of the alkyl groups are the same as those mentioned in the explanation of R⁴. Among those, methyl, ethyl, propyl, iso-propyl, butyl, sec-butyl, tert-butyl and pentyl groups are particularly preferable.

Examples of nitrogen-containing compounds represented by General Formula (4) include 2-imidazolidinone, 1,3-dimethyl-2-imidazolidinone, 1,3-diethyl-2-imidazolidinone, 1,3-dipropyl-2-imidazolidinone, 1,3-dibutyl-2-imidazolidinone, 1,3-dipentyl-2-imidazolidinone, 1,3-diisopropyl-2-imidazolidinone, 1-isopropyl-2-imidazolidinone, 1-isobutyl-2-imidazolidinone, 1-isopentyl-2-imidazolidinone, 1-methyl-2-imidazolidinone, 1-ethyl-2-imidazolidinone, 1-propyl-2-imidazolidinone, 1-butyl-2-imidazolidinone, 1-pentyl-2-imidazolidinone, 1-methyl-3-ethyl-2-imidazolidinone, 1-methyl-3-propyl-2-imidazolidinone, 1-methyl-3-butyl-2-imidazolidinone, 1-methyl-3-pentyl-2-imidazolidinone, 1-ethyl-3-propyl-2-imidazolidinone, 1-ethyl-3-butyl-2-imidazolidinone, etc. Because of its excellent cleaning ability, use of 1,3-dimethyl-2-imidazolidinone, 1,3-diethyl-2-imidazolidinone or 1,3-dipropyl-2-imidazolidinone is particularly preferable.

These halogen-free organic solvents may be used singly or in a desirable combination.

The cleaner composition for the removal of lead-free soldering flux of the present invention essentially uses Components (A) to (C). There are no limitations to the contents of Components (A) to (C) in the composition, but when the total weight of Components (A) to (C) is defined as 100 weight %, the content of Component (A) is generally about 0.1 to 60 weight % and preferably 0.5 to 10 weight %, the content of Component (B) is generally about 0.01 to 10 weight % and preferably 0.05 to 5 weight %, and the content of Component (C) is generally about 39 to 99 weight % and preferably 70 to 99 weight %.

Setting the content of Component (A) in the composition to be 0.1 to 60 weight % can increase the cleaning ability of the composition of the present invention on the insoluble tin salt produced during a soldering step in which a lead-free solder is used. When the content of Component (A) is less than 0.1 weight %, the cleaning ability of the composition of the present invention on the tin salt becomes insufficient, and residues attributable to tin salts may remain. When the content of Component (A) exceeds 60 weight %, which is an excessive addition, no enhancement in the cleaning effects can be observed and corrosion of the cleaned object and like problems may occur.

Setting the content of Component (B) in the composition to be 0.01 to 10 weight % can increase the cleaning ability of the composition of the present invention on the insoluble tin salt produced during a soldering step in which a lead-free solder is used. When the object is washed with water after being cleaned with the composition of the present invention, the solubility of the tin salt in water is increased and re-adhesion of the tin salt during the washing step can effectively be prevented. When the content of Component (B) is less than 0.01 weight %, the tin salt tends to re-adhere to the cleaned object. When the content of Component (B) exceeds 10 weight %, which is an excessive addition, no enhancement in the cleaning effects can be observed and corrosion of the cleaned object and like problems may occur.

When the content of Component (C) in the composition is in the range from 39 to 99 weight %, the solubility of flux components in water is increased, and the removal of flux becomes easier.

The composition of the present invention may further contain at least one member selected from the group consisting of (D) nonionic surfactants (hereunder referred to as Component (D)), and (E) polyoxyalkylene amine-based surfactants (hereunder referred to as Component (E)).

There is no limitation to Component (D) as long as it is a nonionic surfactant other than Components (A) to (C), and known surfactants may be used. An example of Component (D) is a polyalkylene glycol ether-based nonionic surfactant represented by General Formula (5):

R⁸O(CH₂CH₂O)ᵣ—(CH₂CR⁹HO)ₛ—H (5)

wherein R⁸ is a C₆₋₂₀ straight-chain or branched alkyl or phenyl group, or a phenyl group substituted with a C₇₋₁₂ straight-chain or branched alkyl group, R⁹ is a hydrogen atom or methyl group, r is an integer of 0 to 20, s is an integer of 0 to 20, and r+s is an integer of 2 to 20.

Examples of the C₆₋₂₀ straight-chain or branched alkyl group include hexyl, heptyl, octyl, nonyl, decyl, undecyl, dodecyl, tridecyl, palmityl, stearyl groups, etc.

Examples of the phenyl group substituted with a C₇₋₁₂ straight-chain or branched alkyl group are the same as those exemplified in the explanation of R¹.

In General Formula (5), r+s is preferably an integer from 3 to 12.

It is also possible to use, as Component (D), polyalkylene glycol monoesters, polyalkylene glycol diesters and like polyalkylene glycol ester-based nonionic surfactants; ethylene-oxide adducts of fatty acid amides; sorbitan fatty acid esters, sucrose esters of fatty acids and like polyhydric alcohol-based nonionic surfactants; fatty acid alkanolamides; etc.

These nonionic surfactants may be used singly or in combination. Among these, because they can enhance the cleaning ability of the composition of the present invention, polyalkylene glycol ether-based nonionic surfactants are preferable, and polyethylene glycol alkyl ether, polypropylene glycol alkyl ether, polyethylene propylene glycol alkyl ether are particularly preferable.

There is no limitation to Component (E) as long as it is a polyoxyalkylene amine-based surfactant other than Components (A) to (D), and known polyoxyalkylene amine-based surfactants may be used. Because it has excellent cleaning ability, is environmentally friendly and less flammable, among the polyoxyethylene amine-based surfactants, the surfactant represented by General Formula (6):

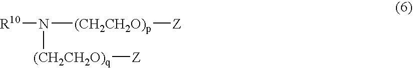

where R¹⁰ is a hydrogen atom, a C₁₋₂₂ straight-chain or branched alkyl or alkenyl group, Z is a hydrogen atom, a C₁₋₄ straight-chain or branched alkyl or acyl group, p is an integer of 1 to 15, and q is an integer of 0 to 15; is particularly preferable.

Examples of the C₁₋₂₂ straight-chain or branched alkyl or alkenyl group include methyl, ethyl, propyl, iso-propyl, butyl, sec-butyl, pentyl, hexyl, octyl, nonyl, dodecyl, tridecyl, palmityl, stearyl, ethenyl, propenyl, butenyl, pentenyl, hexenyl, octenyl, decenyl, dodecenyl groups, etc. Among these, ethyl, propyl, iso-propyl, butyl, sec-butyl, pentyl, hexyl, octyl, nonyl, dodecyl, ethenyl, propenyl, butenyl, pentenyl, hexenyl, octenyl, decenyl, dodecenyl, and tridecenyl and like C₂₋₁₄ straight-chain or branched alkyl and alkenyl groups are particularly preferable.

Examples of the C₁₋₄ straight-chain or branched alkyl or acyl group include methyl, ethyl, propyl, iso-propyl, butyl, sec-butyl, acetyl groups, etc. A preferable example of Z is a hydrogen atom.

In General Formula (6), p is preferably an integer of 1 to 10.

In General Formula (6), q is preferably an integer of 0 to 10.

Particularly preferable examples of the polyoxyethylene amine-based surfactants represented by General Formula (6) include, because the cleaning ability of the composition of the present invention can be enhanced when used after being diluted with water, polyoxyethylene amine-based surfactants, wherein R¹⁰ is a C₂₋₁₈ straight-chain or branched alkyl or alkenyl group, Z is a hydrogen atom, and p+q is an integer of 1 to 15.

When the composition of the present invention contains Component (D), there is no limitation to the content thereof; however, it is generally about 0.1 to 150 parts by weight and preferably 1 to 45 parts by weight per 100 parts by weight of the total weight of Components (A) to (C). When the content of Component (D) is not less than 0.1 part by weight, re-adhesion of the tin salt during the washing step can effectively be prevented. When the content of Component (D) is not greater than 150 parts by weight, the cleaning ability of the composition of the present invention on the tin salt can be increased.

When the composition of the present invention contains Component (E), there is no limitation to the content thereof. However, the content is generally about 0.1 to 150 parts by weight and preferably 0.3 to 15 parts by weight per 100 parts by weight of the total weight of Components (A) to (C). When the content of Component (E) is not less than 0.1 part by weight, the cleaning ability of the composition of the present invention can be enhanced when used after being diluted with water. When the content of Component (E) is not greater than 150 parts by weight, corrosion or the like of the object to be cleaned can be desirably prevented.

The cleaner composition of the present invention may contain a defoaming agent, rust-inhibitor, antioxidant and other additives if necessary. The content of such additives is preferably not greater than about 0.1 weight % per 100 weight % of the composition.

When the cleaner composition of the present invention is used, it is preferable that the composition be dissolved in water. By using the composition in the form of an aqueous solution, the composition becomes less flammable, etc., resulting in a safe usage. When the composition is used in the form of an aqueous solution, the concentration of the composition is generally controlled so as to be not less than about 10 weight %. It is particularly preferable that the concentration of the cleaner composition be adjusted within the range from about 50 to 98 weight %. When the concentration of the cleaner composition falls within the range from 50 to 98 weight %, high cleaning ability can be fully expressed.

There is no limitation to the pH when the cleaner composition of the present invention is used in the form of an aqueous solution; however, it is preferable that the pH be in such a range that does not corrode the object being cleaned. Specifically, the pH of an aqueous solution containing a total of 1 weight % of Components (A), (B) and (C) is preferably about 2 to 10, and more preferably about 5 to 9. Likewise, when the composition of the present invention contains at least one member selected from the group consisting of Components (D) and (E), the pH of an aqueous solution containing a total of 1 weight % of Components (D) and (E) is preferably about 2 to 10, and more preferably about 5 to 9.

The cleaner composition of the present invention can sufficiently remove lead-free soldering flux. In particular, the cleaner composition of the present invention exhibits excellent cleaning ability on insoluble tin salts generated by a reaction during the soldering step wherein a lead-free solder is used.

### Rinsing Agent

Not much of the composition remains on the surface of the cleaned object after cleaning the object using the cleaner composition of the present invention; however, by rinsing the object with the rinsing agent for the removal of lead-free soldering flux of the present invention, remaining residues of the composition on the surface of the cleaned object can be more effectively reduced. Furthermore, the surface of the cleaned object can be made much cleaner (i.e., the concentration of the residual ions on the surface of the cleaned object can be further reduced), and re-adhesion of the once removed flux (in particular insoluble tin salts) can be effectively prevented.

The rinsing agent of the present invention contains a carbonate represented by General Formula (7):

MₐH_{b}(CO₃)_{C} (7)

where a is an integer of 1 or 2, b is an integer of 0 to 2, c is an integer of 1 or 2, and M is a volatile organic base.

Examples of the volatile organic base include ammonia, monomethylamine, dimethylamine, trimethylamine, monoethylamine, diethylamine, triethylamine, etc., but usable volatile organic bases are not limited to these. When a in General Formula (7) is 2, the two organic bases may be the same or different. Among carbonates, ammonium carbonate and ammonium bicarbonate are particularly preferable. When an ammonium carbonate or ammonium bicarbonate is used as the carbonate, because ammonium carbonate and the like decompose and volatilize during the drying step after washing, there is no risk that carbonate residues will re-adhere to the cleaned object.

The rinsing agent of the present invention can be easily prepared by dissolving the carbonate in water. The content of the carbonate in the rinsing agent of the present invention is generally about 0.0001 weight % to about 5 weight %, and preferably 0.01 weight % to 1 weight %. When the content of the carbonate falls within the range of about 0.0001 weight % to 5 weight %, the removal of flux can be remarkably enhanced.

### Method for Removal of Lead-Free Soldering Flux

### (Cleaning Step)

Lead-free soldering flux can be removed by contacting the cleaner composition of the present invention with the lead-free soldering flux.

There is no limitation to the method of removing the lead-free soldering flux as long as the cleaner composition of the present invention is used, and a known method can be employed. An example of the typical cleaning method is explained below wherein the cleaner composition of the present invention is brought into contact with a lead-free solder flux cream on an electronic component.

The most desirable cleaning method can be suitably selected from:

electronic components being cleaned by directly dipping them in the cleaner composition of the present invention or an aqueous solution thereof;

the lead-free soldering flux being washed off by applying an aqueous solution of the cleaner composition to the surfaces of electronic components using a spray;

the cleaner composition being brought into contact with the electronic components and brushed using mechanical means; etc.

When a flip-chip mounted substrate is cleaned, it is necessary to supply the cleaning agent in a space not wider than 50 μm between the flip-chip and the substrate. Therefore, in cleaning a flip-chip mounted substrate, it is preferable to employ, for example, a direct cleaning method using a direct cleaning apparatus as disclosed in JP No. 2621800 (specifically, “Direct Pass”, trademark registered by Arakawa Chemical Industries, Ltd.).

A direct cleaning apparatus is provided with an upright storage tube for accommodating the object to be cleaned, wherein the storage tube has solution-supply holes only through the bottom and is placed without fixation in the body of a cleaning tower that is incorporated in a circulation line of the cleaning agent.

The direct cleaning method is a method for cleaning the object (flip-chip mounted substrate) by forcibly supplying the cleaning agent to the upright storage tube after storing the object in the upright storage tube of the cleaning apparatus. In cleaning the flip-chip mounted substrate, a known cleaning method can be employed with using the direct cleaning apparatus. Examples of known cleaning methods include those using a specific cleaning basket (Japanese Unexamined Patent Publication No. 1997-38604), and various other methods disclosed in, for example, Japanese Unexamined Patent Publication No. 1997-155310, Japanese Unexamined Patent Publication No. 2000-189912, etc.

The conditions under which the composition of the present invention is used, (such as cleaning temperature, cleaning time, etc.) are not particularly limited, and can be suitably selected depending on the concentrations and/or contents of Compositions (A) to (C), the types of flux to be removed, etc. For example, the temperature of the composition when cleaning the object can be suitably selected so that the flux can be satisfactorily removed. The temperature of the aqueous solution is generally about 20 to 80° C. By setting the temperature of the aqueous solution to not lower than 20° C., the solubility of the flux in the aqueous solution can be increased. By setting the temperature of the aqueous solution to not greater than 80° C., the evaporation of water can be suppressed. Therefore, the preferable range of the temperature of the aqueous solution is from about 50 to about 70° C.

The duration of time for contacting the aqueous solution with the flux to be removed can be suitably selected depending on the temperature of the aqueous solution, etc. For example, when lead-free soldering flux on electronic components is removed by a dipping method using an aqueous solution at about 60° C., the flux on the electronic components can be satisfactory removed by dipping the electronic components in the aqueous solution for about 1 to 30 minutes.

### (Rinsing Step)

After contacting the composition of the present invention with the lead-free soldering flux, it is preferable that the resulting cleaned object be rinsed using the rinsing agent of the present invention. By rinsing with the rinsing agent of the present invention, re-adhesion of the flux (especially insoluble tin salts) and retention of the composition on the surface of the cleaned object can be effectively prevented. This makes the surface of the cleaned object much cleaner. The step of rinsing the cleaned object with the rinsing agent of the present invention corresponds to a pre-rinsing step in known methods.

After the pre-rinsing step, it is preferable that the resulting pre-rinsed object be washed with ion-exchanged water, etc. (i.e., conducting a finishing rinsing treatment is preferable).

The object that has been subjected to a pre-rinsing step and/or a finishing rinsing treatment may be dried if necessary.

### EFFECT OF THE INVENTION

When electronic components, semiconductor components and like precision components that have been soldered using lead-free solder are cleaned, use of the cleaner composition of the present invention makes it possible to remove flux satisfactorily without retaining residues especially those attributable to tin salt compounds, which are reaction products.

By using the rinsing agent of the present invention, re-adhesion of flux (especially insoluble tin salts generated by a reaction during the soldering step) to the surface of the cleaned object and residues of the composition can effectively be reduced. This also makes the surface of the cleaned object much cleaner.

The cleaner composition for the removal of lead-free soldering flux of the present invention exhibits high cleaning ability especially on lead-free solder flux cream. As a result, electronic components, semiconductor components and various like precision components, in which lead-free cream solder is used, can be fabricated with high quality and in a safe manner.

### BEST MODE FOR CARRYING OUT THE INVENTION

The present invention is explained below in more detail with reference to the Examples, but the scope of the present invention is not limited to theses Examples.

### Examples 1 to 28 and Comparative Examples 1 to 8

By mixing the components as shown in Tables 1 to 3, each cleaning agent and rinsing agent of Examples 1 to 28 and Comparative Examples 1 to 8 was prepared.

TABLE 1

| | Component | | | | | Component Ratio (wt %) | | | | | |
|---|---|---|---|---|---|---|---|---|---|---|---|
| | A | B | C | D | E | A | B | C | D | E | Water |
| Example 1 | a1 | b1 | c1 | d | e1 | 1 | 0.5 | 80.5 | 10 | 1 | 7 |
| Example 2 | a1 | b1 | c2 | d | e1 | 1 | 0.5 | 80.5 | 10 | 1 | 7 |
| Example 3 | a1 | b2 | c1 | d | e1 | 1 | 0.5 | 80.5 | 10 | 1 | 7 |
| Example 4 | a1 | b2 | c2 | d | e1 | 1 | 0.5 | 80.5 | 10 | 1 | 7 |
| Example 5 | a2 | b1 | c1 | d | e1 | 2 | 1 | 75 | 10 | 2 | 10 |
| Example 6 | a2 | b1 | c2 | d | e1 | 2 | 1 | 75 | 10 | 2 | 10 |
| Example 7 | a2 | b2 | c1 | d | e1 | 2 | 1 | 75 | 10 | 2 | 10 |
| Example 8 | a2 | b2 | c2 | d | e1 | 2 | 1 | 75 | 10 | 2 | 10 |
| Example 9 | a1 | b1 | c1 | d | — | 1 | 0.5 | 81.5 | 10 | — | 7 |
| Example 10 | a1 | b2 | c1 | d | — | 1 | 0.5 | 81.5 | 10 | — | 7 |
| Example 11 | a1 | b3 | c1 | d | e1 | 1 | 1 | 80 | 10 | 1 | 7 |
| Example 12 | a1 | b4 | c1 | d | e1 | 1 | 1 | 80 | 10 | 1 | 7 |
| Example 13 | a1 | b5 | c1 | d | e1 | 1 | 1 | 80 | 10 | 1 | 7 |
| Example 14 | a1 | b6 | c1 | d | e1 | 1 | 1 | 80 | 10 | 1 | 7 |

TABLE 2

| | Component | | | | | Component Ratio (wt %) | | | | | | Rinsing |
|---|---|---|---|---|---|---|---|---|---|---|---|---|
| | A | B | C | D | E | A | B | C | D | E | Water | agent |
| Example 15 | a1 | b7 | c2 | d | e1 | 1 | 1 | 80 | 10 | 1 | 7 | — |
| Example 16 | a1 | b8 | c1 | d | e1 | 1 | 1 | 80 | 10 | 1 | 7 | — |
| Example 17 | a1 | b8 | c2 | d | e1 | 1 | 1 | 80 | 10 | 1 | 7 | — |
| Example 18 | a1 | b9 | c1 | d | e1 | 1 | 1 | 80 | 10 | 1 | 7 | — |
| Example 19 | a1 | b9 | c2 | d | e1 | 1 | 1 | 80 | 10 | 1 | 7 | — |
| Example 20 | a1 | b1 | c1 | d | e2 | 1.5 | 0.2 | 80.8 | 10 | 0.5 | 7 | — |
| Example 21 | a1 | b1 | c2 | d | e2 | 1.5 | 0.2 | 80.8 | 10 | 0.5 | 7 | — |
| Example 22 | a1 | b1 | c1 | d | e3 | 1.5 | 0.2 | 80.8 | 10 | 0.5 | 7 | — |
| Example 23 | a1 | b1 | c1 | d | e2 | 1.5 | 0.2 | 80.3 | 10 | 1 | 7 | — |
| Example 24 | a1 | b1 | c1 | d | e2 | 1.5 | 0.2 | 79.8 | 10 | 1.5 | 7 | — |
| Example 25 | a1 | b2 | c1 | d | e1 | 1 | 0.5 | 80.5 | 10 | 1 | 7 | f1 |
| Example 26 | a1 | b2 | c1 | d | e1 | 1 | 0.5 | 80.5 | 10 | 1 | 7 | f2 |
| Example 27 | a1 | b2 | c1 | d | e1 | 1 | 0.5 | 80.5 | 10 | 1 | 7 | f3 |
| Example 28 | a1 | b2 | c2 | d | e1 | 1 | 0.5 | 80.5 | 10 | 1 | 7 | f1 |

TABLE 3

| | Component | | | | | Component Patio (wt %) | | | | | | Rinsing |
|---|---|---|---|---|---|---|---|---|---|---|---|---|
| | A | B | C | D | E | A | B | C | D | E | Water | agent |
| Comparative | — | — | c1 | d | — | — | — | 83 | 10 | — | 7 | — |
| Example 1 | | | | | | | | | | | | |
| Comparative | — | — | c1 | d | e1 | — | — | 81 | 10 | 2 | 7 | — |
| Example 2 | | | | | | | | | | | | |
| Comparative | a1 | — | c1 | d | — | 2 | — | 81 | 10 | — | 7 | — |
| Example 3 | | | | | | | | | | | | |
| Comparative | — | b1 | c1 | d | — | — | 1 | 82 | 10 | — | 7 | — |
| Example 4 | | | | | | | | | | | | |
| Comparative | a1 | — | c1 | d | e1 | 1 | — | 81 | 10 | 1 | 10 | — |
| Example 5 | | | | | | | | | | | | |
| Comparative | a1 | — | c1 | d | e1 | 1 | — | 81 | 10 | 1 | 10 | f1 |
| Example 6 | | | | | | | | | | | | |
| Comparative | a1 | — | c1 | d | e1 | 1 | — | 81 | 10 | 1 | 10 | f2 |
| Example 7 | | | | | | | | | | | | |
| Comparative | a1 | — | c1 | d | — | 2 | — | 81 | 10 | — | 10 | f3 |
| Example 8 | | | | | | | | | | | | |

In Tables 1 to 3, Component (A) is a polyoxyalkylene phosphate-based surfactant represented by General Formula (1) and a1 is a monoester phosphate of polyoxyethylene alkyl ether (in General Formula (1), R¹ is a C₁₋₂ straight-chain alkyl group, n is 16, and X is a hydroxyl group). a2 is a diester phosphate of polyoxyethylene alkyl ether (in General Formula (1), R¹ is nonylphenyl, n is 10, X is a group represented by General Formula (2) wherein R² is nonylphenyl and m is 10).

Component (B) is a metal chelating agent, wherein b1 is malic acid, b2 is citric acid, b3 is lactic acid, b4 is salicylic acid, b5 is malonic acid, b6 is succinic acid, b7 is glutaric acid, b8 is pyrophosphoric acid, and b9 is polyphosphoric acid.

Component (C) is a halogen-free organic solvent, wherein c1 is diethylene glycol monobutyl ether, and C2 is 1,3-dimethyl-2-imidazolidinone.

Component (D) is a nonionic surfactant, wherein d is a polyethylene glycol alkyl ether-based nonionic surfactant (provided by Dai-Ichi Kogyo Seiyaku Co., Ltd., product name: “Noigen ET-135”. In General Formula (5), R⁸ is a C₁₂₋₁₄ branched alkyl group, R⁹ is a hydrogen atom, and r+s is 9).

Component (E) is a polyoxyalkylene amine surfactant, wherein e1 is a polyoxyethylene alkyl amine (In General Formula (6), R¹⁰ is a C₁₋₂ straight-chain alkyl group, p+q is 10, and Z is a hydrogen atom). e2 is a polyoxyethylene alkyl amine (in General Formula (6), R¹⁰ is a C₂ straight-chain alkyl group, p=q=1, and Z is a hydrogen atom). e3 is a polyoxyethylene alkyl amine (in General Formula (6), R¹⁰ is a C₄ straight-chain alkyl group, p=q=1, and Z is a hydrogen atom).

Component (F) is an aqueous solution of a carbonate. f1 is a 0.5% aqueous solution of ammonium carbonate (in General Formula (7), a=2, b=0, and c=1). f2 is a 1% aqueous solution of the ammonium carbonate. f3 is a 0.5% aqueous solution of ammonium bicarbonate (in General Formula (7), a=1, b=1, and c=1).

### Preparation of Contaminated Liquid

A lead-free cream solder, TASLF219Y (provided by Arakawa Chemical Industries, Ltd., ratio of metal components: Sn/3.0Ag/0.5Cu) was applied to a copper plate. The flux was removed by heating the applied lead-free cream solder on a hot plate at 250° C. Each contaminated liquid was prepared by dissolving the flux in a cleaner composition obtained in each Example and Comparative Example in such a manner that the concentration of the flux became 5 weight %.

The cleaner compositions prepared in Examples and Comparative Examples and the contaminated liquids were subjected to the following experiments.

A lead-free cream solder, TASLF219Y (provided by Arakawa Chemical Industries, Ltd., ratio of metal components: Sn/3.0Ag/0.5Cu) was printed on a copper pattern of a glass epoxy substrate (copper clad laminate of 20×20 mm) and then soldered based on the following reflow profiles, obtaining experimental substrates.

### Reflow Profiles

Preheating: 150-160° C., 90 seconds

Peak temperature: 250° C.

Reflow conditions: not less than 220° C., about 30 seconds

### Examples 1 to 23 and Comparative Examples 1 to 5

The thus-prepared experimental substrates were subjected to the treatments as described in Items 1) to 3) below.

1) Immersion in each cleaner composition (unused solution) or contaminated liquid at 70° C. for 5 minutes;

2) Immersion in ion-exchanged water at 40° C. for 5 minutes twice; and

3) Drying by hot air at 80° C. for 10 minutes.

The treated experimental substrates were evaluated for their (1) cleaning ability (removal of flux) and (2) cleanliness by the method described in Experimental Examples 1 and 2 below.

### Examples 25 to 28, and Comparative Examples 6 to 8

The thus-prepared experimental substrates were subjected to the treatments as described in Items 1) to 4) below.

1) Immersion in one cleaner composition (unused solution) or contaminated liquid at 70° C. for 5 minutes;

2) Immersion in the rinsing agent solution shown in Tables 2 and 3 at 30° C. for 5 minutes;

3) Immersion in ion-exchanged water at 40° C. for 5 minutes twice; and

4) Drying by hot air at 80° C. for 10 minutes.

The treated experimental substrates were evaluated for their (1) cleaning ability (removal of flux) and (2) cleanliness by the method described in Experimental Examples 1 and 2 below.

### Experimental Example 1

### Evaluation of Cleaning Ability (Removal of Flux)

The levels of flux removal from the surfaces of the experimental substrates were visually observed and evaluated based on the following criteria. Tables 4 to 6 show the results.

1: Flux was satisfactory removed (the area of flux residue was 0%).

2: Small amount of flux remained (the area of flux residue was greater than 0% but not greater than 10%).

3: A large amount of flux remained (the area of flux residue exceeded 10%).

### Experimental Example 2

### Evaluation of Cleanliness

The cleanliness (remaining ion concentration) of the surfaces of the experimental substrates was measured using an Omega Meter 600R-SC (provided by Alpha Metals, Inc.). Tables 4 to 6 show the results.

The values of cleanliness shown in Tables 4 to 6 were obtained by converting the total amounts of ions remaining on the surfaces of the experimental substrates into the amounts of NaCl ion.

TABLE 4

| | pH of Aqueous | | | Cleanliness | |
|---|---|---|---|---|---|
| | Solution Containing | Cleaning Ability | | (μg/inch²) | |
| | 1 Weight % Cleaner | Unused | Contaminated | Unused | Contaminated |
| | Composition | Solution | Solution | Solution | Solution |
| Example 1 | 4.2 | 1 | 1 | 0.3 | 0.4 |
| Example 2 | 4.3 | 1 | 1 | 0.4 | 0.4 |
| Example 3 | 4.2 | 1 | 1 | 0.6 | 0.6 |
| Example 4 | 4.3 | 1 | 1 | 0.5 | 0.6 |
| Example 5 | 4.1 | 1 | 1 | 0.5 | 0.5 |
| Example 6 | 4.1 | 1 | 1 | 0.4 | 0.5 |
| Example 7 | 4.0 | 1 | 1 | 0.5 | 0.5 |
| Example 8 | 4.0 | 1 | 1 | 0.6 | 0.6 |
| Example 9 | 3.5 | 1 | 1 | 0.5 | 0.5 |
| Example 10 | 3.5 | 1 | 1 | 0.3 | 0.4 |
| Example 11 | 4.4 | 1 | 1 | 0.6 | 0.7 |
| Example 12 | 4.2 | 1 | 1 | 0.7 | 0.7 |
| Example 13 | 4.2 | 1 | 1 | 0.6 | 0.7 |
| Example 14 | 4.3 | 1 | 1 | 0.6 | 0.6 |

TABLE 5

| | pH of Aqueous | | | Cleanliness | |
|---|---|---|---|---|---|
| | Solution Containing | Cleaning Ability | | (μg/inch²) | |
| | 1 Weight % Cleaner | Unused | Contaminated | Unused | Contaminated |
| | Composition | Solution | Solution | Solution | Solution |
| Example 15 | 4.1 | 1 | 1 | 0.5 | 0.6 |
| Example 16 | 4.4 | 1 | 1 | 0.3 | 0.4 |
| Example 17 | 4.4 | 1 | 1 | 0.4 | 0.4 |
| Example 18 | 4.2 | 1 | 1 | 0.4 | 0.5 |
| Example 19 | 4.3 | 1 | 1 | 0.5 | 0.5 |
| Example 20 | 6.6 | 1 | 1 | 0.3 | 0.4 |
| Example 21 | 6.4 | 1 | 1 | 0.3 | 0.4 |
| Example 22 | 6.6 | 1 | 1 | 0.3 | 0.3 |
| Example 23 | 8.0 | 1 | 1 | 0.4 | 0.5 |
| Example 24 | 8.5 | 1 | 1 | 0.5 | 0.6 |
| Example 25 | 4.2 | 1 | 1 | 0.3 | 0.3 |
| Example 26 | 4.2 | 1 | 1 | 0.3 | 0.4 |
| Example 27 | 4.2 | 1 | 1 | 0.3 | 0.3 |
| Example 28 | — | 1 | 1 | 0.4 | 0.4 |

TABLE 6

| | pH of | | | | |
|---|---|---|---|---|---|
| | Aqueous | | | | |
| | Solution | | | | |
| | Containing 1 | | | Cleanliness | |
| | Weight % | Cleaning Ability | | (μg/inch²) | |
| | Cleaner | Unused | Contaminated | Unused | Unused |
| | Composition | Solution | Solution | Solution | Solution |
| Comparative | 5.0 | 3 | 3 | 5.6 | 6.3 |
| Example 1 | | | | | |
| Comparative | 7.8 | 3 | 3 | 4.6 | 5.2 |
| Example 2 | | | | | |
| Comparative | 3.8 | 2 | 3 | 1.8 | 2.2 |
| Example 3 | | | | | |
| Comparative | 3.5 | 2 | 3 | 2.6 | 3.3 |
| Example 4 | | | | | |
| Comparative | 6.5 | 2 | 3 | 1.6 | 2.3 |
| Example 5 | | | | | |
| Comparative | 6.5 | 1 | 2 | 0.4 | 1.2 |
| Example 6 | | | | | |
| Comparative | 6.5 | 1 | 2 | 0.3 | 1.3 |
| Example 7 | | | | | |
| Comparative | 3.8 | 1 | 2 | 0.4 | 1.6 |
| Example 8 | | | | | |

1. A cleaner composition for removing lead-free soldering flux comprising:
(A) a polyoxyalkylene phosphate-based surfactant;
(B) a metal chelating agent; and
(C) a halogen-free organic solvent.

2. A cleaner composition for removing lead-free soldering flux according to claim 1, wherein the (A) polyoxyalkylene phosphate-based surfactant is a polyoxyethylene phosphate-based surfactant represented by General Formula (1) or a salt thereof: 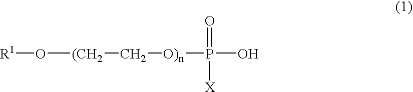
where R¹ is a C₅₋₂₀ straight-chain or branched alkyl or phenyl group, or a phenyl group substituted with a C₇₋₁₂ straight-chain or branched alkyl group, n is an integer of 0 to 20, and X is a hydroxyl group or a group represented by General Formula (2):
R²—O(CH₂CH₂—O)ₘ— (2)
where R² is a C₅₋₂₀ straight-chain or branched alkyl or phenyl group, or a phenyl group substituted with a C₇₋₁₂ straight-chain or branched alkyl group, and m is an integer of 0 to 20.

3. A cleaner composition for removing lead-free soldering flux according to claim 1, wherein the (B) metal chelating agent is at least one member selected from the group consisting of hydroxycarboxylic acid-based chelating agents, carboxylic acid-based chelating agents and phosphoric acid-based chelating agents.

4. A cleaner composition for removing lead-free soldering flux according to claim 1, which further comprises at least one member selected from the group consisting of (D) nonionic surfactants and (E) polyoxyalkylene amine-based surfactants.

5. A cleaner composition for removing lead-free soldering flux according to claim 1, wherein the (C) halogen-free organic solvent is at least one member selected from the group consisting of a glycol ether compound represented by General Formula (3): 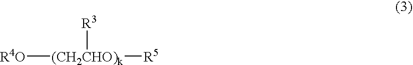
wherein R³ is a hydrogen atom or a methyl group, R⁴ is a hydrogen atom or a C₁₋₅ straight-chain or branched alkyl group, R⁵ is a C₁₋₅ straight-chain or branched alkyl group, and k is an integer of 2 to 4; and
a nitrogen-containing compound represented by General Formula (4): 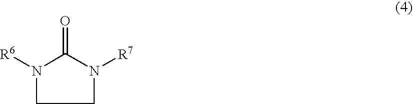
where R⁶ is a hydrogen atom or a C₁₋₅ straight-chain or branched alkyl group, R⁷ is a hydrogen atom or a C₁₋₅ straight-chain or branched alkyl group.

6. A cleaner composition for removing lead-free soldering flux according to claim 4, wherein the (D) nonionic surfactant is a nonionic surfactant represented by General Formula (5):
R⁸O—(CH₂CH₂O)ᵣ—(CH₂CR⁹HO)ₛ—H (5)
where R⁸ is a C₆₋₂₀ straight-chain or branched alkyl or phenyl group, or a phenyl group substituted with a C₇₋₁₂ straight-chain or branched alkyl group, R⁹ is a hydrogen atom or a methyl group, r is an integer of 0 to 20, s is an integer of 0 to 20, and r+s is an integer of 2 to 20.

7. A cleaner composition for removing lead-free soldering flux according to claim 4, wherein the (E) polyoxyalkylene amine-based surfactant is a polyoxyethylene amine-based surfactant represented by General Formula (6): 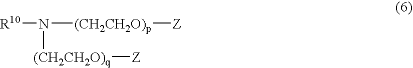
where R¹⁰ is a hydrogen atom or a C₁₋₂₂ straight-chain or branched alkyl or alkenyl group, Z is a hydrogen atom or a C₁₋₄ straight-chain or branched alkyl or acyl group, p is an integer of 1 to 15, and q is an integer of 0 to 15.

8. A cleaner composition for removing lead-free soldering flux according to claim 1, wherein the contents of the components of the (A) polyoxyalkylene phosphate-based surfactant, (B) metal chelating agent, and (C) halogen-free organic solvent are (A) 0.1 to 60 weight %, (B) 0.01 to 10 weight %, and (C) 39 to 99 weight % respectively when the total weight of the three components is defined as 100 weight %.

9. A cleaner composition for removing lead-free soldering flux according to claim 4, which contains 0.1 to 150 parts by weight of the (D) nonionic surfactant when the total amount of the (A) polyoxyalkylene phosphate-based surfactant, (B) metal chelating agent, and (C) halogen-free organic solvent is defined as 100 parts by weight.

10. A cleaner composition for removing lead-free soldering flux according to claim 4, which contains 0.1 to 150 parts by weight of the (E) polyoxyalkylene amine-based surfactant when the total amount of the (A) polyoxyalkylene phosphate-based surfactant, (B) metal chelating agent, and (C) halogen-free organic solvent is defined as 100 parts by weight.

11. A cleaner composition for removing lead-free soldering flux according to claim 1, wherein an aqueous solution that contains 1 weight % of (A) polyoxyalkylene phosphate-based surfactant, (B) metal chelating agent, and (C) halogen-free organic solvent in total has a pH of 2 to 10.

12. A rinsing agent for removing lead-free soldering flux containing a carbonate represented by General Formula (7):
MₐH_{b}(CO₃)_{C} (7)
where a is an integer of 1 or 2, b is an integer of 0 to 2, c is an integer of 1 or 2, and M is a volatile organic base.

13. A method for removing lead-free soldering flux comprising a step of removing flux by contacting the cleaning composition of claim 1 with a lead-free soldering flux.

14. A method for removing lead-free soldering flux comprising a step of, after contacting the cleaning composition of claim 1 with a lead-free soldering flux, rinsing using a rinsing agent to remove the lead-free soldering flux,
the rinsing agent containing a carbonate represented by General Formula (7):
MₐH_{b}(CO₃)_{C} (7)
where a is an integer of 1 or 2, b is an integer of 0 to 2, c is an integer of 1 or 2, and M is a volatile organic base.
